(19) United States
(12) Patent Application Publication
(10) Pub. No.: US 2024/0048522 A1
(43) Pub. Date: Feb. 8, 2024

(54) PROCESSING DEVICE, INFORMATION PROCESSING METHOD, AND RECORDING MEDIUM

(71) Applicant: M.D.B Corporation, Shibuya-ku, Tokyo (JP)

(72) Inventors: Kei Shinmi, Tokyo (JP); Hiroko Takahashi, Tokyo (JP)

(73) Assignee: M.D.B Corporation, Shibuya-ku, Tokyo (JP)

(21) Appl. No.: 18/269,463

(22) PCT Filed: Mar. 23, 2021
(86) PCT No.: PCT/JP2021/011934

§ 371 Date: Jun. 23, 2023

(51) Int. Cl. H04L 51/52

(52) U.S. Cl. CPC H04L 51/52; G06V 40/20

(57) ABSTRACT

The information processing device according to the third embodiment includes a determination means and a transmission means. The determination means determines a state of a target animal based on a physical quantity of information related to movement or behavior of the target animal. The transmission means transmits message information corresponding to the determined state to a terminal device.

### TECHNICAL FIELD

The present disclosure relates to a technique for transmitting messages related to an animal.

### BACKGROUND ART

There is a need that pet owners want to grasp the state and behavior of the pets in their homes during their work or when they are going out. Patent Document 1 describes a system which detects a state of a pet by a sensor terminal, generates utterance data of a first person on the basis of the detected data, and performs conversation with the owner or other user by an interactive SNS.

### PRECEDING TECHNICAL REFERENCES

### Patent Document

Patent Document 1: International Publication WO2016/125478

### SUMMARY

### Problem to be Solved

When transmitting a conversation message based on the state of the pet as described in Patent Document 1, there is a tendency that the message transmitted to the owner becomes simple and one-pattern, although the state and behavior of the pet serving as a trigger of the message transmission is various. In order to enjoy comfortable conversation with the pet, it is desired to send an appropriate message to the owner based on the state of the pet.

It is an object of the present disclosure to transmit appropriate message information to the owner based on the state of the pet.

### Means for Solving the Problem

According to an example aspect of the present disclosure, there is provided an information processing device comprising:
a determination means configured to determine a state of a target animal based on a physical quantity of information related to movement or behavior of the target animal; and
a transmission means configured to transmit message information corresponding to the determined state to a terminal device.

According to another example aspect of the present disclosure, there is provided an information processing method comprising:
determining a state of a target animal based on a physical quantity of information related to movement or behavior of the target animal; and
transmitting message information corresponding to the determined state to a terminal device.

According to still another example aspect of the present disclosure, there is provided a recording medium recording a program, the program causing a computer to:
determine a state of a target animal based on a physical quantity of information related to movement or behavior of the target animal; and
transmit message information corresponding to the determined state to a terminal device.

### Effect

According to the present disclosure, it is possible to transmit appropriate message information to the owner based on the state of the pet.

### BRIEF DESCRIPTION OF THE DRAWINGS

FIG. 1 shows an overall configuration of a communication system to which an information processing device is applied.

FIG. 2 shows an example of a floor plan of home of an owner.

FIG. 3 is a block diagram showing a configuration of a home system.

FIG. 4 is a block diagram showing a configuration of a pet terminal.

FIGS. 5A and 5B are block diagrams showing configurations of a server and a user terminal.

FIG. 6 shows an example of determining a state of a pet when a vibration count is used as a physical quantity.

FIG. 7 shows examples of message information corresponding to a state or a state change of a pet.

FIG. 8 shows an example of transmitting message information by the server.

FIG. 9 shows a flowchart of message information transmission processing.

FIG. 10 is a block diagram showing a functional configuration of an information processing device of a third example embodiment.

FIG. 11 is a flowchart of processing executed by the information processing device of the third example embodiment.

### EXAMPLE EMBODIMENTS

### First Example Embodiment

[Overall Configuration]

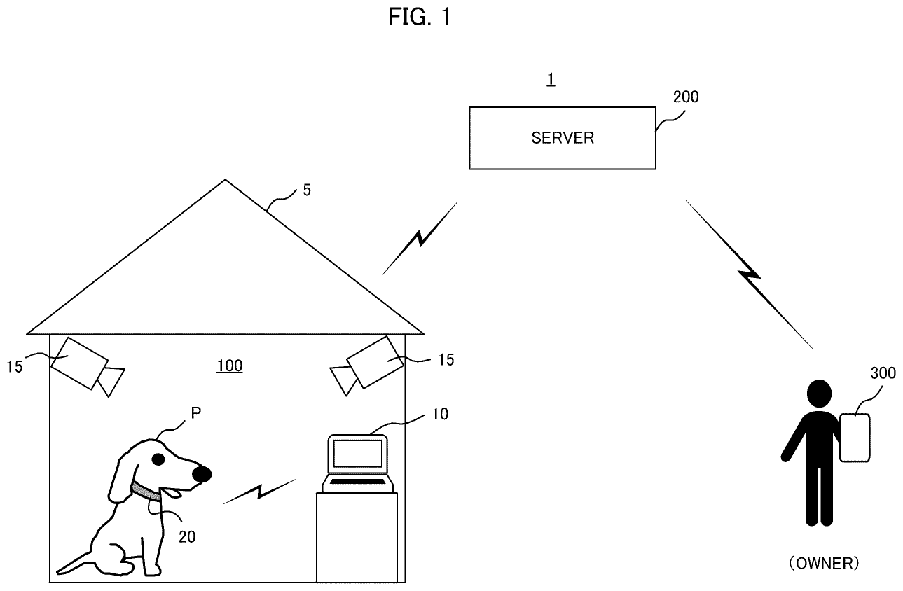

FIG. 1 shows an overall configuration of a communication system to which an information processing device according to the present disclosure is applied. The communication system 1 includes a home system 100 installed in a home 5 of an owner of a pet, a server 200, and a user terminal 300 used by the owner. The pet P is staying at the home 5 of the owner, and a pet terminal 20 is attached to the pet P. Further, fixed cameras 15 are installed in predetermined locations in the home 5. The home system 100 and the server 200 can communicate by wired or wireless communication. The server 200 can also communicate wirelessly with the user terminal 300 of the owner.

As a basic operation, the server 200 generates message information about the pet P based on the location, the behavior and the state of the pet P (hereinafter referred to as the “state of the pet P”), and transmits the message information to the user terminal 300 of the owner via an interactive SNS (Social Network Service). Here, the message information includes a text message, a stamp, and the like.

Specifically, when the transmission timing arrives, the server 200 transmits the message information expressing the state of the pet P at that time well to the user terminal 300 of the owner via the interactive SNS. The owner can know the state of the pet P by viewing the message information transmitted to the user terminal 300.

The message information generated may be based on the behavior, the location, and the state of pet P. The transmission timing of the message information may be arbitrary set. For example, the message information may be transmitted initially from the pet side when the state of the pet changes. Also, the message information may be transmitted based on the request of the owner. It is also possible to perform interactive conversation such that the owner transmits the image or message to the pet P and the pet P returns the image or message or stamp to the owner. For example, when the owner transmits the message “Did you have a meal?”, the pet P may return the image of the rice and the stamp. Further, the pet P may transmit the message information with a predetermined time interval.

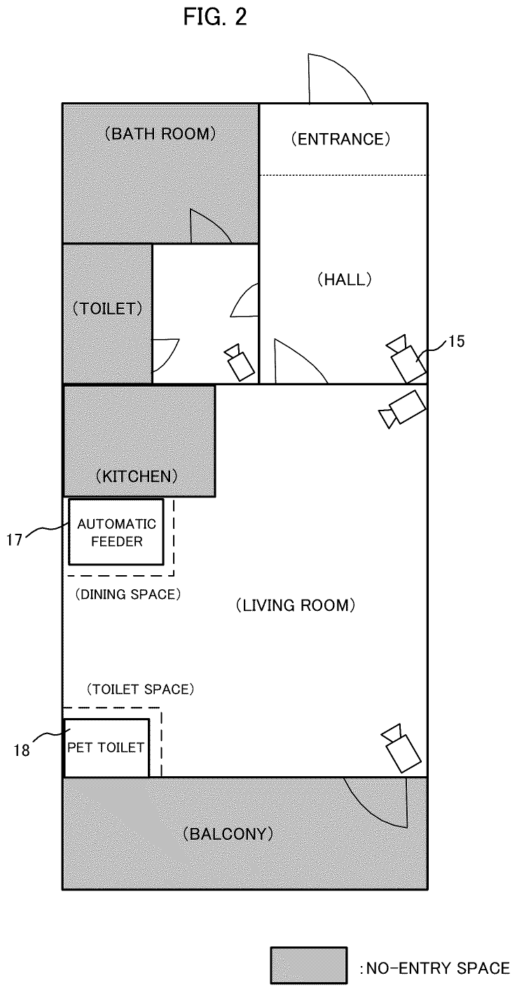

FIG. 2 shows an example of a floor plan of the owner's home 5. The home 5 has an entrance, hall, bathroom, toilet, living room, kitchen, balcony, etc. The door partitioning each space is basically open, and the pet P can move each space freely. In each space, a fixed camera 15 for capturing the state of the pet P is installed. Some of the spaces in the home 5 are decided to be the spaces where the pet P should not enter (hereinafter referred to as “no-entry spaces”). The no-entry spaces include a space to which the entry is not allowed because it is dangerous for the pet P, and a space to which the entry is not allowed because the pet P may do mischief. In the example of FIG. 2, the bathroom, toilet, kitchen, and balcony shown in gray color are determined to be the no-entry spaces.

[Home System]

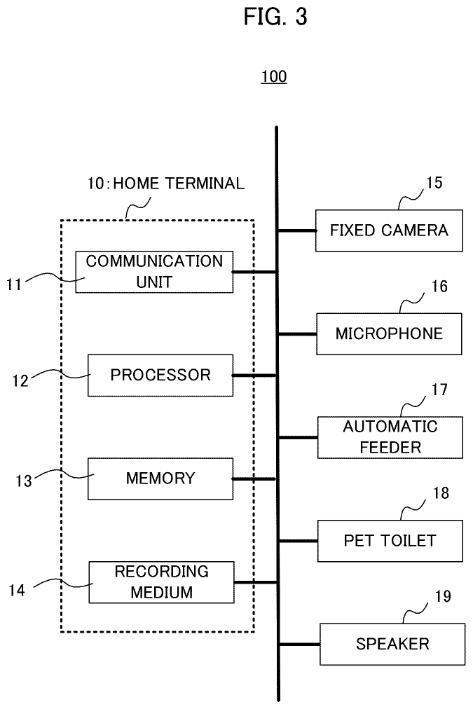

FIG. 3 is a block diagram showing a configuration of the home system 100 installed in the home 5. In the example of FIG. 3, the home system 100 includes a home terminal 10, the fixed cameras 15, a microphone 16, an automatic feeder 17, a pet toilet 18, and a speaker 19. However, the home system 100 may include, not all of the above-described elements, but some of them. The home terminal 10 is, for example, a terminal device such as a PC, a tablet, or a smartphone, and includes a communication unit 11, a processor 12, a memory 13, and a recording medium 14.

The communication unit 11 communicates with an external device. Specifically, the communication unit 11 wirelessly communicates with the pet terminal 20 attached to the pet P by Bluetooth (registered trademark), for example. The communication unit 11 communicates with the server 200 in a wired or wireless manner.

The processor 12 is a computer such as a CPU (Central Processing Unit) and controls the entire home terminal 10 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 transmits information related to the pet to the server 200 by executing a program prepared in advance.

The memory 13 may be a ROM (Read Only Memory) and a RAM (Random Access Memory). The memory 13 stores various programs executed by the processor 12. The memory 13 is also used as a working memory during various processes executed by the processor 12.

The recording medium 14 is a non-volatile and non-transitory recording medium such as a disk-like recording medium and a semiconductor memory, and is configured to be detachable from the home terminal 10. The recording medium 14 records various programs executed by the processor 12. When the home terminal transmits data related to the state of the pet P to the server 200, the program recorded on the recording medium 14 is loaded into the memory 13 and executed by the processor 12. The images captured by the fixed cameras 15, the sound collected by the microphone 16, information received from the pet terminal 20, and the like are temporarily stored in the memory 13.

The fixed cameras 15 are installed at predetermined positions in the home Basically, a necessary number of fixed cameras 15 are installed so as to cover the entire spaces in which the pet P can move. In particular, the fixed cameras 15 are installed at the positions to shoot the video of the areas including the no-entry spaces of the pet P. The fixed cameras 15 are always operating to shoot the video of the shooting range, and transmit the video to the home terminal 10.

The microphone 16 is installed in each space of the home 5. The microphone 16 may be integrated with the fixed camera 15. The microphone 16 collects the sound generated in each space, and transmits the sound to the home terminal 10. The home terminal 10 transmits the sound collected by the microphone 16 to the server 200.

The automatic feeder 17 is provided in the dining space in the living room as shown in FIG. 2. The automatic feeder 17 is a device to feed the pet P when the owner is absent. For example, the automatic feeder 17 automatically supplies the feed to the dish for the pet at a time set in advance, and transmits a notice indicating that the feed was given to the pet P to the home terminal 10. The home terminal 10 transmits the notice from the automatic feeder 17 to the server 200. The home terminal 10 also transmits, to the server 200, the images captured by the fixed camera 15 around the time of receiving the notice.

The pet toilet 18 is installed in the toilet space in the living room as shown in FIG. 2. The pet toilet 18 includes, for example, a water absorbing sheet and a sensor, detects excretion of the pet P, and sends a notice to the home terminal 10. The home terminal 10 transmits the notice from the pet toilet 18 to the server 200. The home terminal 10 also transmits, to the server 200, the images captured by the fixed camera 15 around the time of receiving the notice.

The speaker 19 is installed in the living room or the no-entry space of the home 5, and outputs a warning sound and a message for the pet P. For example, by recording a scolding voice of the owner (“Don't enter there!”) in advance, the same voice can be outputted to the pet when the pet P enters the no-entry space, even when the owner is not present.

[Pet Terminal]

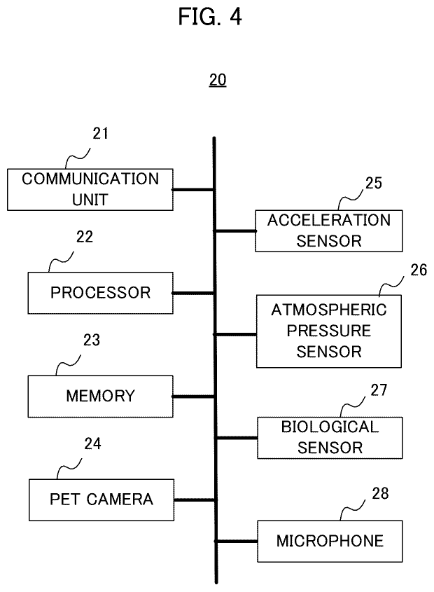

FIG. 4 is a block diagram showing a configuration of the pet terminal 20 attached to the pet P. The pet terminal 20 may be attached to the pet instead of the collar of the pet P or attached to the collar that the pet is wearing, for example. The pet terminal 20 includes a communication unit 21, a processor 22, a memory 23, a pet camera 24, an acceleration sensor 25, an atmospheric pressure sensor 26, a biological sensor 27, and a microphone 28.

The communication unit 21 communicates with an external device. Specifically, the communication unit 21 wirelessly communicates with the home terminal 10 by Bluetooth (registered trademark), for example.

The processor 22 is a computer, such as a CPU, that controls the entire pet terminal 20 by executing a predetermined program. The processor 12 periodically transmits the information acquired by the pet camera 24, each of the sensors 25 to 27 and the microphone 28 to the home terminal 10 by executing a program prepared in advance.

The memory 23 is configured by a ROM, RAM or the like. The memory 23 stores various programs executed by the processor 22. The memory 23 is also used as a working memory during various processes executed by the processor 22. Furthermore, the memory 23 temporarily stores information detected by the pet camera 24, each of the sensors 25 to 27 and the microphone 28.

The pet camera 24 is a camera for shooting the image of the pet′ view. The pet camera 24 may be configured to detect the orientation of the neck of the pet P to determine the shooting direction, may be mounted near the head of the pet P, or may be a camera that shoots the front of the pet P at a wide angle. The pet camera 24 shoots an area including the viewing direction of the pet P and transmits the shot images to the home terminal 10. Thus, the home terminal 10 can acquire the images of the pet's view.

The acceleration sensor 25 is a three-axis acceleration sensor, which measures the motion of the pet P in the three-axis direction and transmits it to the home terminal 10. Specifically, the acceleration sensor 25 can output the movement amount or a vibration count of the pet P. Based on the output of the acceleration sensor 25, the server 200 can estimate the activity amount of the pet P or the like. The atmospheric pressure sensor 26 measures the atmospheric pressure at the place of the pet P and transmits it to the home terminal 10. Based on the output of the atmospheric pressure sensor 26, the server 200 can detect the number of times, the distance and the accumulated distance of the vertical movement of the pet P, e.g., a jump. Further, although not shown in FIG. 4, a gyro sensor may be used. A six-axis sensor in which a three-axis acceleration sensor and a three-axis gyro sensor (a three-axis angular velocity sensor) are integrated may be used. The sensor is not limited to the above-described one as long as the sensor can measure the activity amount of the animal.

The biological sensor 27 is a sensor for measuring the biological information of the pet P. For example, the biological sensor 27 measures the body temperature, the heart rate and the respiration rate of the pet P, and transmits them to the home terminal 10. The home terminal 10 transmits the acquired biological information to the server 200.

The microphone 28 collects the sound around the pet P and transmits the sound to the home terminal 10. The home terminal 10 transmits the sound to the server 200. The server 200 can estimate the state of the pet P such as yelping or barking, based on the received sound. The server 200 can estimate the motion state, the mental state, or the like of the pet based on the sound of the pet P running around or the breath sound, for example.

[Server]

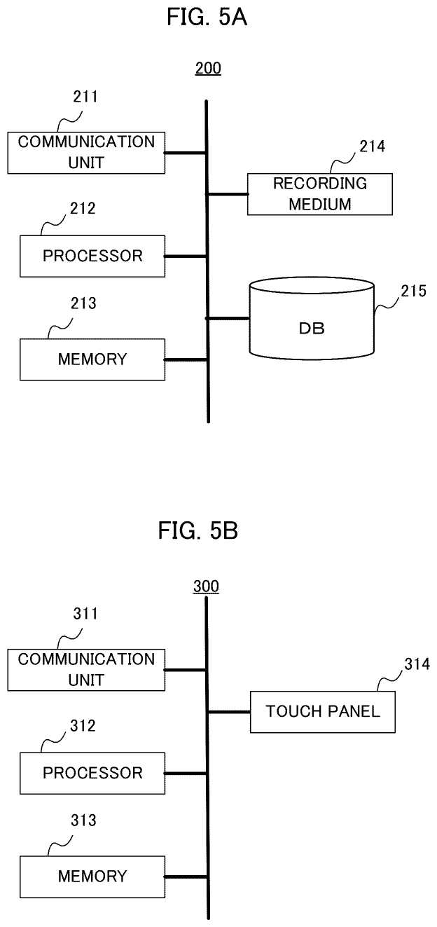

FIG. 5A is a block diagram illustrating a configuration of the server 200. The server 200 transmits messages to and receives messages from the user terminal 300 by the interactive SNS. The server 200 includes a communication unit 211, a processor 212, a memory 213, a recording medium 214, and a database 215.

The communication unit 211 transmits and receives data to and from an external device. Specifically, the communication unit 211 transmits and receives information to and from the home terminal 10 and the user terminal 300 of the owner.

The processor 212 is a computer, such as a CPU, that controls the entire server 200 by executing a program prepared in advance. The processor 212 may be a GPU, a FPGA, a DSP, an ASIC or the like. Specifically, the processor 212 transmits message information to the owner's user terminal 300 by the interactive SNS. The processor 212 is an example of a determination means and a transmission means.

The memory 213 is configured by a ROM, RAM, or the like. The memory 213 is also used as a working memory during various processes executed by the processor 212. The recording medium 214 is a non-volatile and non-transitory recording medium such as a disk-like recording medium or a semiconductor memory and is configured to be detachable from the server 200. The recording medium 214 records various programs executed by the processor 212.

The database 215 stores information and images received from the home terminal 10 through the communication unit 211. That is, message information and images transmitted and received by the users of a plurality of user terminals 300 are stored in the database 215. Further, the database 215 stores, for each user, the transmission timing of the message information, and the message information prepared in advance (e.g., a predetermined message, stamp, etc.). The database 215 is an example of a storage unit. The server 200 may include an input unit such as a keyboard and a mouse to allow an administrator to give instructions or input, and a display unit such as a liquid crystal display.

[User Terminal]

FIG. 5B is a block diagram illustrating an internal configuration of the user terminal 300 used by the owner. The user terminal 300 is, for example, a smartphone, a tablet, a PC, or the like. The user terminal 300 includes a communication unit 311, a processor 312, a memory 313, and a touch panel 314.

The communication unit 311 transmits and receives data to and from the external device. Specifically, the communication unit 311 transmits and receives information to and from the server 200.

The processor 312 is a computer, such as a CPU, and controls the entire user terminal 300 by executing a program prepared in advance. The processor 312 may be a GPU, a FPGA, a DSP, an ASIC or the like. Specifically, the user terminal 300 is installed with a messaging application for the interactive SNS executed by the server 200. The “messaging application” is an application that provide exchange of information such as text messages, stamps, still images and videos. The processor 312 receives the transmitted message information through the server 200 by the messaging application and displays them on the touch panel 314. The processor 312 also transmits message information inputted by the owner to the server 200 through the messaging application.

The memory 313 is configured by a ROM and a RAM. The memory 313 is also used as a working memory during various processing by the processor 312. The touch panel 314 displays the message information received by the user terminal 300. The touch panel 314 also functions as an input device of a user.

[Transmission of Message Information]

Next, transmitting the message information to the user terminal 300 of the owner will be described. In the present example embodiment, the server 200 transmits the message information of appropriate contents to the user terminal 300 of the owner based on the state of the pet P. More specifically, the server 200 determines the state of the pet P based on the size of the physical quantity related to the movement or behavior of the pet P, and transmits the message information corresponding to the determined state to the user terminal 300 of the owner.

(Determination of Pet State)

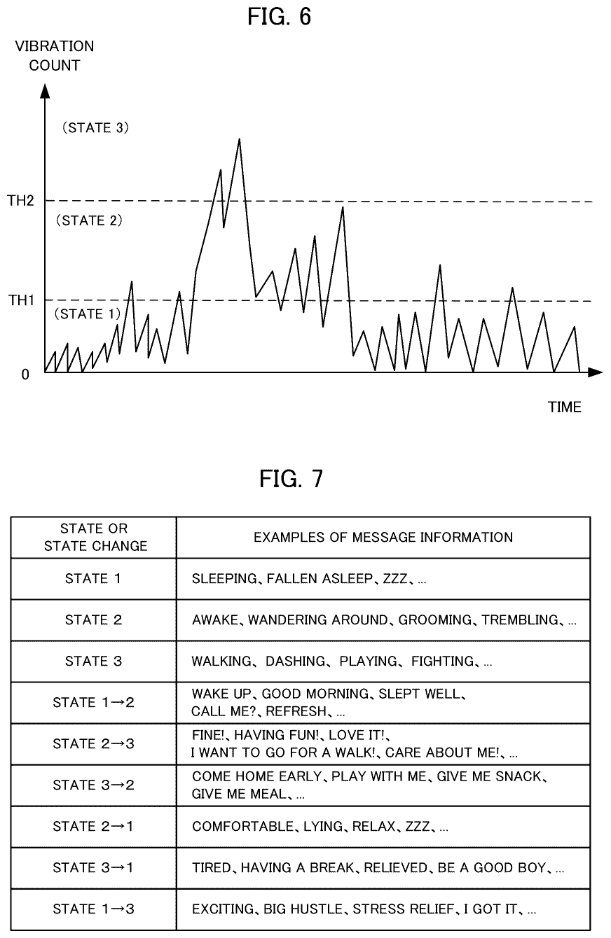

The server 200 acquires the physical quantity regarding the movement or the behavior of the pet P from the pet terminal 20 and determines the state of the pet P. FIG. 6 shows an example of determining the state of the pet when a vibration count acquired from the pet terminal 20 is used as the physical quantity. The vibration count is only an example of a physical quantity indicating the state of the pet P, and is not limited thereto.

FIG. 6 shows a graph of the vibration count of the pet P measured by the pet terminal 20. In this example, the server 200 classifies the state of the pet P into the states 1 to 3 based on the vibration count. Note that this classification is merely an example, and the method of classifying the state of the pet P is not limited to this example. The state 1 is the case where the vibration count is smaller than the threshold TH1, and the pet P is sleeping. The state 2 is the case where the vibration count is equal to or larger than the threshold TH1 and is smaller than the threshold TH2, and the pet P is performing a short movement or a small movement (hereinafter, referred to as a “small movement state”). The state 3 is the case where the vibration count is equal to or larger than the threshold TH2, and the pet P is performing a long movement or a large movement (hereinafter, referred to as “large movement state”). As shown in FIG. 6, the state of the pet P changes from moment to moment based on the change in the vibration count.

The server 200 determines the message information to be transmitted to the owner according to the state of the pet P. The server 200 may determine the message information according to the time change of the state of the pet P. FIG. 7 shows examples of the message information prepared in connection with the state or the state change of the pet P. The message information of FIG. 7 are merely examples, and other message information may be used. The server 200 randomly selects one or more message information from a plurality of message information prepared for each state or state change, and transmits the information to the user terminal 300.

If the pet P is in the state 1 (i.e., the sleeping state), the server 200 selects the message information expressing that the pet P is in a sleeping state, such as “sleeping,” “fallen asleep”, for example. If the pet P is in the state 2 (i.e., the small movement state), the server 200 selects the message information expressing that the pet P is awake and doing daily activities, for example, “awake,” “wandering around,” and the like. If the pet P is in the state 3 (i.e., the large movement state), the server 200 selects the message information expressing that the pet P is in an active state, for example, “walking,” “dashing,” and the like. Thus, by using the size of the physical quantity regarding the movement or behavior of the pet P, it is possible to finely determine the state of the pet P including the size (degree) of the movement or behavior.

In addition, when the state of the pet P changes from one of the states 1 to 3 to another, the server 200 selects the message information corresponding to the change. For example, as illustrated in FIG. 7, when the state of the pet P changes from the state 1 (i.e., the sleeping state) to the state 2 (i.e., the small movement state), the server 200 selects the message information such as “wake up”, “Good morning.” When the state of the pet P changes from the state 2 (i.e., the small movement state) to the state 3 (i.e., the large movement state), the server 200 selects the message information such as “Fine!” or “Having fun!”, for example. Similarly, the message information as illustrated in FIG. 7 is selected for the other state changes. Thus, by using the time change of the physical quantity regarding the movement or behavior of the pet P, it is possible to determine the state of the pet P that changes from moment to moment in more detail. While a text message is used as the message information in the example of FIG. 7, a stamp or an image may be used.

While the state of the pet P is classified into three states in the above example, one or more of those states may be further subdivided. For example, state 1 (i.e., the sleeping state) may be subdivided into “Sound sleep,” “Shallow sleep,” “Just lying on the side,” etc. In this case, the server 200 may subdivide the state 1 by subdividing the threshold used for the classification of the states 1 to 3. For example, if the threshold TH1 of the vibration count is “10”, the server 200 may determine that the vibration count “0” to “3” correspond to “Sound sleep”, that the vibration count “4” to “7” correspond to “Shallow sleep”, and the vibration count “8” to “10” correspond to “Just lying on the side”. Alternatively, the server 200 may combine the vibration count with the values of other sensors to determine a subdivided classification. Specifically, the sleeping state may be subdivided based on biological information of the pet P, e.g., the body temperature, heart rate, respiration rate, and the like, in addition to the vibration count.

In the above example, the vibration count is used as a physical quantity to be used for determination of the state of the pet P, but other various physical quantity can be used as long as it is a physical quantity showing information on the movement and behavior of the pet P. For example, instead of the vibration count, the activity amount, acceleration, heart rate, respiration rate, or the like of the pet P can be used. Further, not only the physical quantity directly measured by a sensor or the like, the physical quantity obtained indirectly from other information may be used. For example, the activity amount of the pet P may be digitized by image analysis processing of the images captured by the camera or by analysis of the sound collected by the microphone, and the state of the pet P may be determined using the result of the digitization.

In the above example, the state of the pet P is determined based on the vibration count which is one physical quantity. However, the state of the pet P may be determined based on a combination of a plurality of physical quantities. In that case, the combination of the plurality of physical quantities may be classified into a plurality of states, and the message information may be stored in association with the plurality of states.

It is noted that the method of determining the state is not limited to the methods described above.

(Message Information)

As described above, the server 200 randomly selects the message information prepared for each state or state change of the pet P as illustrated in FIG. 7, and transmits the message information to the owner's user terminal 300. As an alternative to randomly selecting the message information, the server 200 may select message information according to a time or a time zone. For example, the server 200 may select “Good Morning”, “Woke up” or the like if the pet P starts activity in the morning, and select “Good job for today” or the like in the evening when the work of the owner is about to end. Also, the server 200 may select the message information to be transmitted based on the history of the message information transmitted in the past. For example, the message information transmitted in the recent two to three days may be excluded from the choices so that the message information to be transmitted does not become one pattern.

The server 200 may select the message information to be transmitted depending on the attributes or the like of the owner. The attributes of the owner include the character, gender, and age of the owner, and the number of years the owner is keeping the pet. The server 200 prepares the correspondence information between the attributes of the owner and the transmission frequency, the contents, and the type of the message information to be transmitted in advance. Incidentally, the correspondence information may be generated in advance based on questionnaire results for a large number of pet lovers, for example. The owner sets and stores his or her own attribute information in the server 200. The server 200 selects and transmits the message information based on the attribute information set by the owner. For example, the server 200 may continuously transmit multiple message information or transmit the message information more frequently if the owner is a worrier.

The server 200 may change the message information transmitted to the owner according to an attribute, a character, or the like of the pet. Specifically, the attributes of the pet include the type (e.g., dog, cat, rabbit, hamster, bird, etc.), breed, age, gender, and character of the pet. The character of the pet may be inferred based on the type, gender or age of the pet, or may be set by the owner in advance. For example, dogs are relatively obedient to their owners, cats are capricious, and Chihuahuas are smaller in size but have a strong character.

For example, the server 200 may change the mouth tone of the message information according to the type, age, character, or the like of the pet P. For example, the server 200 may transmit the message information such as “I want you to come back soon . . . ” when the pet P waiting for the owner's return has a gentle character, and may transmit the message information such as “Return soon!” when the pet P has a strong character.

Also, the server 200 may sometimes transmit the message information that is not relevant to the determination result of the state of the pet P. For example, the server 200 may transmit the message information that is not meaningful or does not relate to the behavior of the pet P to the owner once or twice a day. Thus, it is possible to increase the entertainment in the conversation with the pet P.

(Example of Transmitting Message Information)

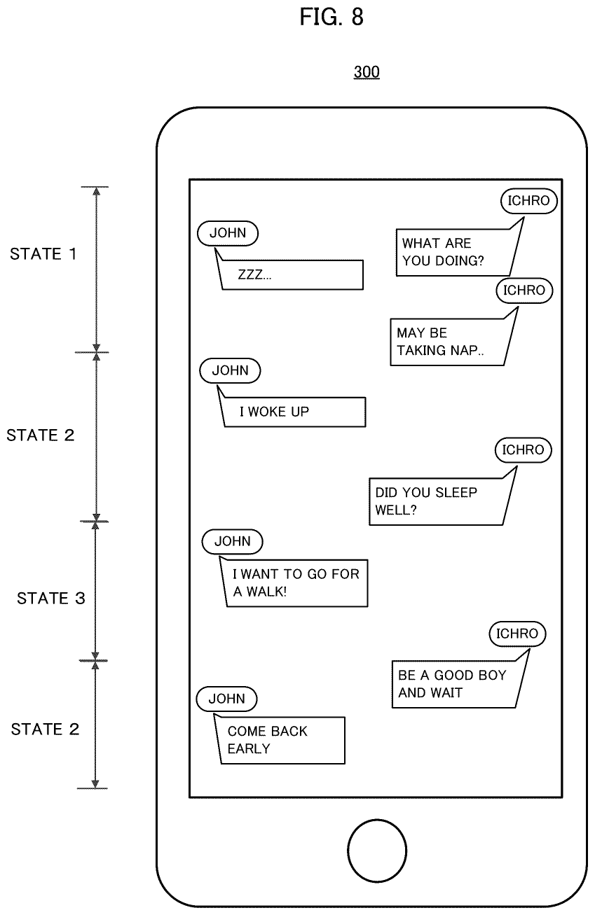

FIG. 8 shows an example of transmitting the message information by the server 200. FIG. 8 is an example of displaying the message information in the user terminal 300 of the owner. Note that the name the owner is “Ichiro” and the name of the pet P is “John”.

First, the owner sent the message “What are you doing?”. At that time, the pet P was in the state 1 (the sleeping state), and the server 200 transmitted the message information “ZZZ . . . ” corresponding to the state 1 to the owner, as shown in FIG. 7. In response, the owner sent the message “Maybe taking nap . . . ”

Thereafter, when the state of the pet P changed from the state 1 to the state 2 (the small movement state), the server 200 transmitted the message information “I woke up!” corresponding to the change from the state 1 to the state 2 as shown in FIG. 7. In response, the owner sent the message “Did you sleep well?”.

Thereafter, when the state of the pet P changed from the state 2 to the state 3 (the large movement state), the server 200 transmitted the message information “I want to go for a walk!” corresponding to the change from the state 2 to the state 3 as shown in FIG. 8. In response, the owner transmitted the message information “Be a good boy and wait”.

Thereafter, when the state of the pet P returned from the state 3 to the state 2, the server 200 transmitted the message information “Come back early” corresponding to the change from the state 3 to the state 2, as shown in FIG. 8. Thus, according to the present example embodiment, since appropriate

message information is transmitted to the user terminal 300 of the owner in accordance with the state or the state change of the pet P, the owner can see the message information corresponding to the state of the pet P changing from time to time.

[Message Information Transmission Processing]

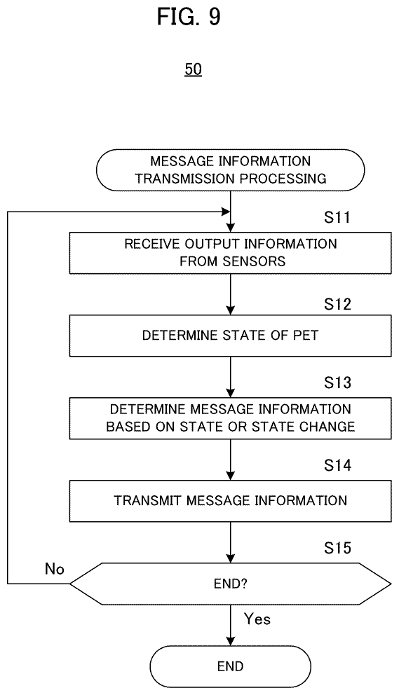

FIG. 9 is a flowchart illustrating message information transmission processing executed by the server 200. This processing is realized by the processor 212 shown in FIG. 5, which executes a program prepared in advance.

First, the server 200 receives, from the home terminal 10, the output information from the sensors of the pet terminal 20 attached to the pet P, the fixed cameras 15, the microphone 16, the automatic feeder 17, and the pet toilet 18 (step S11).

Next, the servers 200 determines the state of the pet P based on the information acquired in step S11 (step S12). Specifically, the server 200 determines the state of the pet P based on the physical quantity (in the above-described example, the vibration count) included in the information acquired from the home terminal 10. The server 200 determines the message information based on the state or the state change of the pet P thus determined (step S13), and transmits the message information to the user terminal 300 of the owner (step S14).

Next, the server 200 determines whether or not the message information transmission processing is ended (step S15). Normally, the owner operates the user terminal 300 to turn on the message information transmission processing by the server 200 when he or she goes out, and turns off the message information transmission processing when he or she arrives home. Therefore, the message information transmission processing continues until the owner turns off the message information transmission processing, and when the owner turns it off (step S15: Yes), the message information transmission processing ends.

It is noted that the process in step S15 is not limited to the above process. For example, the server 200 may stop transmitting the message information when it is determined that the owner is at home based on the position information of the user terminal 300 or other information. Specifically, the server 200 determines whether or not the owner is at home based on the position information of the user terminal 300. If it is determined that the owner is at home, the server 200 does not transmit the message information. The position of the owner can be acquired by a GPS, for example. Further, the server 200 may determine whether or not the owner is at home based on presence or absence of the connection of the user terminal 300 to the home Wi-Fi, and does not transmit the message when it is determined that the owner is at home.

[Modification]

(Modification 1)

In the first example embodiment described above, basically the information acquired by various devices and the pet terminal 20 installed in the home 5 are transmitted to the server 200 as they are, and the server 200 performs a state analysis or the like to determine the state of the pet P on the basis of the information received. Instead, a part of the processing for determining the state of the pet P may be performed by the home terminal 10 and the processing result may be transmitted to the server 200. For example, the feature extraction or the like from the images may be performed on the home terminal 10 side, and the result may be transmitted to the server 200. This reduces the communication load from the home terminal 10 to the server 200 and the processing load on the server 200.

### Second Example Embodiment

In the first example embodiment described above, the information acquired by the various devices and the pet terminal 20 installed in the home 5 are transmitted to the server 200, and the server 200 determines the state of the pet P and transmits the message information to the user terminal 300. Alternatively, the function of the server 200 may be performed by the home terminal 10 of the home system. That is, the home terminal 10 may determine the state of the pet P based on the information outputted from the various devices installed in the home 5 and the pet terminal 20, and determines the message information based on the determination result to transmit the message information to the user terminal 300.

In this case, the interactive SNS messaging application is installed in the home terminal 10. When the home terminal 10 determines the state of the pet P, it sets the owner's user terminal 300 as the destination and transmits the message information using the messaging application. The message information are transmitted to the owner's user terminal 300 by the interactive SNS of the server 200. Incidentally, except for the above points, the second example embodiment is the same as the first example embodiment.

### Third Example Embodiment

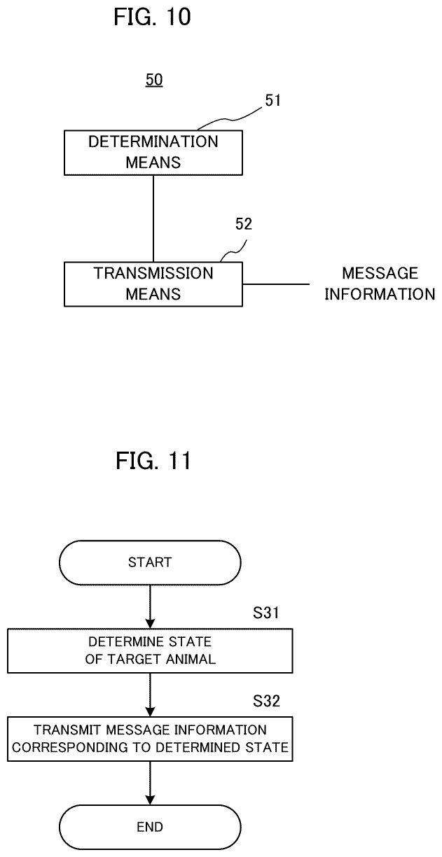

FIG. 10 is a block diagram illustrating a functional configuration of an information processing device according to a third example embodiment. The information processing device according to the third embodiment includes a determination means 51 and a transmission means 52. The determination means 51 determines a state of a target animal based on a physical quantity of information related to movement or behavior of the target animal. The transmission means 52 transmits message information corresponding to the determined state to a terminal device.

FIG. 11 is a flowchart of processing executed by the information processing device 50. The determination means 51 determines a state of a target animal based on a physical quantity of information related to movement or behavior of the target animal (step S31). The transmission means 52 transmits message information corresponding to the determined state to a terminal device (step S32). According to the information processing device 50 of the third example embodiment, it is possible to transmit appropriate message information according to the state of the target animal to the terminal device of the owner.

A part or all of the example embodiments described above may also be described as the following supplementary notes, but not limited thereto.

(Supplementary Note 1)

An information processing device comprising:
a determination means configured to determine a state of a target animal based on a physical quantity of information related to movement or behavior of the target animal; and
a transmission means configured to transmit message information corresponding to the determined state to a terminal device.

(Supplementary Note 2)

The information processing device according to Supplementary note 1, wherein the determination means determines the state of the target animal based on size of the physical quantity.

(Supplementary Note 3)

The information processing device according to Supplementary note 1 or 2, wherein the determination means determines the state of the target animal based on a time change of the physical quantity.

(Supplementary Note 4)

The information processing device according to any one of Supplementary notes 1 to 3,
wherein the determination means determines whether the state of the target animal corresponds to any one of a plurality of states, and
wherein the transmission means transmits the message information corresponding to the determined state.

(Supplementary Note 5)

The information processing device according to Supplementary note 4, further comprising a storage unit configured to store the message information associated with each of the plurality of states,
wherein the transmission unit acquires the message information corresponding to the determined state from the storage unit and transmits the acquired message information.

(Supplementary Note 6)

The information processing device according to any one of Supplementary notes 1 to 5, wherein the transmission means transmits the message information according to a time or a time zone.

(Supplementary Note 7)

The information processing device according to any one of Supplementary notes 1 to 5, wherein the physical quantity includes at least one of a vibration count, an acceleration, a heart rate, and a respiration rate measured by a sensor attached to the target animal.

(Supplementary Note 8)

An information processing method comprising:
determining a state of a target animal based on a physical quantity of information related to movement or behavior of the target animal; and
transmitting message information corresponding to the determined state to a terminal device.

(Supplementary Note 9)

A recording medium recording a program, the program causing a computer to:
determine a state of a target animal based on a physical quantity of information related to movement or behavior of the target animal; and
transmit message information corresponding to the determined state to a terminal device.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

10 Home terminal
15 Fixed camera
16 Microphone
17 Automatic feeder
18 Pet toilet
19 Speaker
20 Pet terminal
24 Pet camera
27 Biological sensor
100 Home system
200 Server
300 User terminal

What is claimed is:

1. An information processing device comprising:
a memory configured to store instructions; and
one or more processors configured to execute the instructions to:
determine a state of a target animal based on a physical quantity of information related to movement or behavior of the target animal; and
transmit message information corresponding to the determined state to a terminal device.

2. The information processing device according to claim 1, wherein the one or more processors determine the state of the target animal based on size of the physical quantity.

3. The information processing device according to claim 1, wherein the one or more processors determine the state of the target animal based on a time change of the physical quantity.

4. The information processing device according to claim 1,
wherein the one or more processors determine whether the state of the target animal corresponds to any one of a plurality of states, and
wherein the one or more processors transmit the message information corresponding to the determined state.

5. The information processing device according to claim 4, further comprising a storage unit configured to store the message information associated with each of the plurality of states,
wherein the one or more processors acquire the message information corresponding to the determined state from the storage unit and transmit the acquired message information.

6. The information processing device according to claim 1, wherein the one or more processors transmit the message information according to a time or a time zone.

7. The information processing device according to claim 1, wherein the physical quantity includes at least one of a vibration count, an acceleration, a heart rate, and a respiration rate measured by a sensor attached to the target animal.

8. An information processing method comprising:
determining a state of a target animal based on a physical quantity of information related to movement or behavior of the target animal; and
transmitting message information corresponding to the determined state to a terminal device.

9. A non-transitory computer-readable recording medium recording a program, the program causing a computer to:
determine a state of a target animal based on a physical quantity of information related to movement or behavior of the target animal; and
transmit message information corresponding to the determined state to a terminal device.
